(19) United States
(12) Patent Application Publication
(10) Pub. No.: US 2023/0359253 A1
(43) Pub. Date: Nov. 9, 2023

(54) Solid-State Drive with Detachable Capacitor Housing Portion

(71) Applicant: INNOGRIT TECHNOLOGIES CO., LTD., Shanghai (CN)

(72) Inventors: Yanwen BAI, Shanghai (CN); Shiann-Ming LIOU, Shanghai (CN); Band CHEN, Shanghai (CN)

(21) Appl. No.: 18/143,412

(22) Filed: May 4, 2023

(30) Foreign Application Priority Data
May 6, 2022 (CN) 202210488118.8

(51) Int. Cl. G06F 1/18

(52) U.S. Cl. CPC G06F 1/181

(57) ABSTRACT

The present disclosure provides a solid-state drive with detachable capacitor housing portion. The solid-state drive comprises a first housing portion, a second housing portion and a capacitor housing portion, wherein the first housing portion and the second housing portion are detachably connected and the capacitor housing is detachably connected to at least one of the first housing portion or the second housing portion. A metal dome is embedded in the capacitor housing portion, the solid-state drive is provided with a printed circuit board. When the metal dome is connected to the connecting point(s) on the printed circuit board, an electrical signal is generated to indicate whether the capacitor housing portion and the printed circuit board are correctly installed.

### TECHNICAL FIELD

The present disclosure relates to the field of solid-state drive (SSD), and in particular to a SSD with a detachable capacitor housing portion.

### BACKGROUND

Taking U.2 SSD as an example, enterprise or industrial level SSD typically have power loss protection modules in their circuits to avoid accidental data loss. At present, power loss protection modules in SSD mainly include electrolytic capacitor, for example, Aluminium electrolytic capacitor or other electrolytic capacitor.

Taking Aluminium electrolytic capacitor as an example, the advantages are low cost, large capacitance, and the disadvantages are short life, usually only 2-3 years. The service life of some manufacturers’ electrolytic capacitor will be shorter. The service life of U.2 SSD including the main components, for example, controller, flash memory and DDR SDRAM, may reach 5 years. The short life of Aluminium electrolytic capacitor restricts the service life of U.2 SSD. When the service life of the Aluminium electrolytic capacitor in the U.2 SSD ends, the SSD needs to be returned to the supplier and replaced with a new Aluminium electrolytic capacitor. Before return to the supplier, the data in the SSD must be securely backed up. This process is generally cumbersome, time-consuming, and carries data security risks.

In addition, referring to FIGS. 1A and 1B, the existing SSD includes a closed casing consisting of a top cover 11 and a bottom cover 12. The components in the drive, for example, electrolytic capacitors 13, are connected to the printed circuit board 14 which is connected to the casing by screws. The casing design is closed. If the electrolytic capacitor 13 is to be taken out, it further needs to remove the screws and open the closed casing. This process is cumbersome and it may also damage the bonding state of the thermal pad or thermal glue, affecting the service life of the SSD. Generally, the electrolytic capacitor 13 has a large size and the design spaces for the top cover 11 and the bottom cover 12 located in its upper and lower sides are small, so that the upper and lower parts of the casing (the top cover 11 and the surface of the bottom cover 12 parallel to the top cover 11) are generally metal plane design, which is easy to lead to bending or deformation.

### SUMMARY

In order to improve or solve at least one problem mentioned in the background, the present disclosure provides a SSD with a detachable capacitor housing portion.

The SSD comprises a first housing portion, a second housing portion and a capacitor housing. The first housing portion and the second housing are detachably connected, and the capacitor housing is detachably connected to at least one of the first housing portion or the second housing portion.

A metal dome is embedded in the capacitor housing portion, the SSD is provided with a printed circuit board. When the capacitor housing portion is connected to at least one of the first housing portion or the second housing portion, the metal dome is configured to connect to connection point(s) on the printed circuit board, and an electrical signal is generated to indicate whether the capacitor housing portion and the printed circuit board are correctly installed.

In at least one embodiment, the capacitor housing portion has a snap structure, the first housing portion and the second housing portion are provided with a snap fitting structure, and the capacitor housing portion is configured to be snapping fit with the first housing portion and the second housing portion.

In at least one embodiment, the snap structure includes a protruding portion, the snap fitting structure includes a recessed portion, and the protruding portion is configured to be snapping fit with the recessed portion.

In at least one embodiment, the capacitor housing portion is inserted into and connected to the first housing portion or the second housing portion.

In at least one embodiment, the capacitor housing portion is connected to at least one of the first housing portion or the second housing portion through screws.

In at least one embodiment, the capacitor housing portion includes a surface provided with a fin structure.

In at least one embodiment, the capacitor housing portion is made of plastic or carbon fiber.

In at least one embodiment, the SSD also includes an electrolytic capacitor that is exposed when the capacitor housing is removed.

In at least one embodiment, the capacitor housing portion is connected to both the first housing portion and the second housing portion, and the capacitor housing portion has a U-shaped section.

In at least one embodiment, the metal dome has a U-shaped cross section and the metal dome is configured to clamp the printed circuit board so that the metal dome touches the connection point(s) on the printed circuit board and the electrical signal is configured to serve as an indicator by converting into data display, optical signal, or acoustic signal.

The SSD proposed in the present disclosure has a detachable capacitor housing portion, which makes it easy to replace the electrolytic capacitor, extends the service life of the SSD, eliminates the complicated work of data backup, and improves the data security. The provision of the metal dome facilitates checking whether the capacitor housing portion and printed circuit board are correctly installed, improving the checking efficiency, and reducing the possibility of incorrect installing.

### BRIEF DESCRIPTION OF THE DRAWINGS

FIG. 1A is a schematic view showing a structure of an existing SSD.

FIG. 1B is a schematic view showing a section of the SSD in FIG. 1A.

FIG. 2A is a schematic view showing a structure of the SSD according to the embodiment of the present disclosure.

FIG. 2B is a schematic view showing a section of the SSD in FIG. 2A.

FIG. 3 is a schematic view showing a snap structure of the SSD according to the embodiment of the present disclosure.

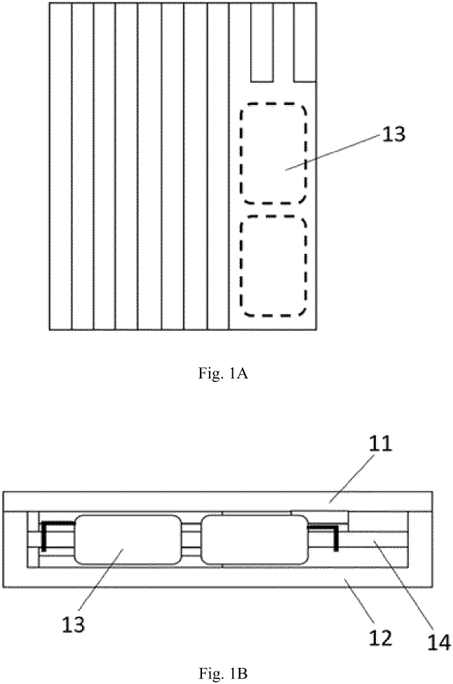

### DESCRIPTION OF REFERENCE SIGNS

11 Top cover; 12 bottom cover; 13 electrolytic capacitor; 14 printed circuit board;
21 First housing portion; 22 second housing portion; 23 capacitor housing portion; 24 electrolytic capacitor; 25 snap structure; 251 protruding portion; 26 snap fitting structure; 261 recessed portion; 27 metal dome; 28 printed circuit board.

### DETAILED DESCRIPTION

The following describes exemplary embodiments of the present disclosure with reference to the accompanying drawings. It should be appreciated that these specific instructions are only intended to illustrate how a person skilled in the art implements the present disclosure, not intended to exhaust all feasible methods of the present disclosure, nor are they intended to limit the scope of the present disclosure.

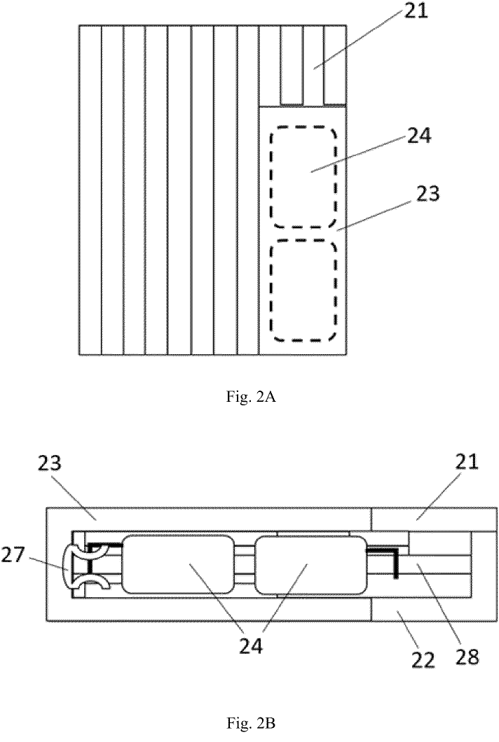

The present disclosure provides a SSD with a detachable capacitor housing portion. Referring to FIGS. 2A and 2B, the SSD comprises a first housing portion 21, a second housing portion 22 and a capacitor housing portion 23. For example, the first housing portion 21 is cover plate-like, and the second housing portion 22 is a housing body with a U-shaped (or recessed) cross section (for example, the longitudinal section at the left portion in FIG. 2A or the cross section on the upper portion in FIG. 2A). The first housing 21 and the second housing 22 are allowed to be fastened together by screws or other means. Of course, the shape and the connection mode of the first housing portion 21 and the second housing portion 22 are not limited thereto.

The capacitor housing portion 23 is detachably connected to at least one of the first housing portion 21 or the second housing portion 22. For example, the capacitor housing portion 23 is configured to only detachably connect to the first housing portion 21, the capacitor housing portion 23 is configured to only detachably connect to the second housing portion 22, or the capacitor housing portion 23 is configured to detachably connect to both the first housing portion 21 and the second housing portion 22. Below, the present disclosure proposes a plurality of embodiments to further illustrate the connection relationship between the capacitor housing portion 23 and the first housing portion 21, the second housing portion 22.

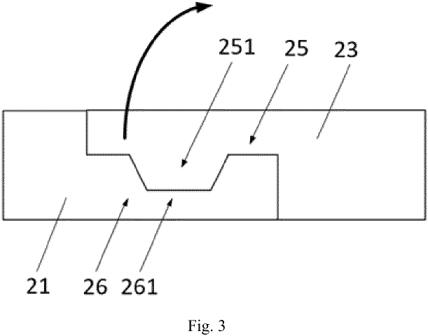

Referring to FIG. 3, in one embodiment of the present disclosure, the capacitor housing portion 23 has a snap structure 25 which includes a protruding portion 251. The first housing portion 21 or the second housing portion 22 has a snap fitting structure 26 which includes a recessed portion 261. The protruding portion 251 is able to extend into and snap fit with the recessed portion 261, causing the capacitor housing portion 23 to snap fit and connect with the first housing portion 21 or the second housing portion 22.

The capacitor housing portion 23 may be made of plastic or carbon fiber, which has a certain elasticity, allowing the capacitor housing portion 23 to be snapping fit or be separated under the action of force (as shown by the curved arrow line in FIG. 3, the capacitor housing portion 23 is allowed to be separated therefrom), allowing the capacitor housing portion 23 to be disassembled separately from other housings. Although the hardness of carbon fiber material is relatively high, the capacitor housing portion 23 is relatively thin and still has some elasticity. The capacitor housing portion 23 made of carbon fiber is able to be used normally. Of course, the present disclosure does not limit the specific shape of the snap structure 25 and the snap fitting structure 26.

The capacitor housing portion 23 has a U-shaped section, which is more benefit to separating the snapping-fit components. The snapping-fit mode makes the disassembly process of the capacitor housing portion 23 simple. The capacitor housing portion 23 may be easily disassembled without professional personnel and professional places, so that the user of the SSD can replace the electrolytic capacitor exposed by removing the capacitor housing portion 23 by himself.

As shown in FIG. 2B, a metal dome 27 is embedded in the capacitor housing portion 23, the cross section of the metal dome 27 may be U-shaped, and the SSD may include a printed circuit board 28. When the capacitor housing portion 23 is connected to at least one of the first housing portion 21 or the second housing 22 (the capacitor housing portion 23 is installed on the SSD), the metal dome 27 may clamp the printed circuit board 28, and the metal dome 27 may contact the connecting points of the printed circuit board 28 (for example, wires, pads, pins on the printed circuit board 28), causing the corresponding circuit to conduct and generate electrical signals. For example, this electrical signal may be converted into specific signals, for example, numerical displays, indicator lights, and beeps to indicate whether the capacitor housing portion 23 and the printed circuit board 28 are correctly installed, making it easier for the installer to check. For example, while checking the SSD in the factory stage, a checker may quickly check whether the printed circuit board 28 is correctly installed and whether the capacitor housing portion 23 is correctly installed by installing the capacitor housing portion 23. For example, in the check after replacing the electrolytic capacitor of the SSD, it is convenient for the checker to know whether the capacitor housing portion 23 is correctly installed.

The clamping relationship between the metal dome 27 and the printed circuit board 28 also plays a certain positioning role, facilitating the installing of the capacitor housing portion 23. The capacitor housing portion 23 as a whole is U-shaped and the capacitor housing portion 23 is installed in a position parallel to the SSD. The capacitor housing portion 23 in this shape and installing mode helps the metal dome 27 to clamp the printed circuit board 28. However, the design of style, for example, a flip cover is not benefit to providing the metal dome 27 and the clamping process between the metal dome 27 and the printed circuit board 28 is also difficult to achieve, which is not benefit to checking whether the capacitor housing portion 23 is correctly installed.

In one embodiment of the present disclosure, the capacitor housing portion 23 may be inserted into and connected to at least one of the first housing portion 21 or the second housing portion 22, so that the capacitor housing portion 23 is configured to be disassembled separately. For example, a plug is provided on the capacitor housing portion 23, at least one of the first housing portion 21 or the second housing 22 is provided with a socket, and the capacitor housing portion 23 is fixed with the at least one of the first housing portion 21 or the second housing portion 22 through the socket and the plug.

In one embodiment of the present disclosure, the capacitor housing portion 23 is configured to be connected to at least one of the first housing portion 21 or the second housing portion 22 through screws, allowing the capacitor housing portion 23 to be disassembled separately.

In one embodiment of the present disclosure, the capacitor housing portion 23 may not be flush with the first housing portion 21 and the second housing portion 22, and a fin structure may be provided on the capacitor housing portion 23 to facilitate heat dissipation.

The SSD proposed in the present disclosure also includes electrolytic capacitors 24. The electrolytic capacitors 24 are configured to be set at the positions corresponding to the capacitor housing portion 23. When the capacitor housing portion 23 is removed (disassembled), the electrolytic capacitors 24 are exposed to the SSD, which facilitates replacing the electrolytic capacitors 24.

In the prior art, the housings on the upper and lower sides of the electrolytic capacitors 24 of the SSD are traditional metal plates, which are difficult to process and easy to bend, thus affecting the entire top or bottom surface of the SSD. In the present disclosure, the housings on the upper and lower sides of the electrolytic capacitors 24 are replaced with the capacitor housing portion 23 made of plastic or carbon fiber. The capacitor housing portion 23 is convenient for processing and replacement and does not affect the housings at other positions.

When replacing the electrolytic capacitors with traditional technology, the drive needs to be returned to the manufacturer for special removal. The process of removing the closed casing is complicated and the removal process may damage other components in the SSD. The SSD proposed in the present disclosure may only remove the capacitor housing portion at the positions corresponding to the electrolytic capacitors without disassembling the whole housing. This removal process is allowed to be completed in the use scenario of the drive, for example, a data center, without returning to the factory and arranging traditional removal sites and tools. This process is allowed to replace the electrolytic capacitor quickly and safely, save the replacement time, reduce the risk of data damage and leakage, and increase service life of the SSD.

Of course, the SSD may also include components, for example, the printed circuit board.

The above is the preferred embodiments of the present disclosure. It should be pointed out that for those skilled in the art, several improvements and embellishments is allowed to be made without departing from the principles of the present disclosure. These improvements and embellishments should also be considered to be within the scope of protection of the present disclosure.

What is claimed is:

1. A solid-state drive with detachable capacitor housing portion, comprising a first housing portion, a second housing portion, and the capacitor housing portion, wherein the first housing portion and the second housing portion are detachably connected, the capacitor housing portion is detachably connected to at least one of the first housing portion or the second housing portion, and wherein
a metal dome is embedded in the capacitor housing portion, the solid-state drive is provided with a printed circuit board, and when the capacitor housing portion is connected to at least one of the first housing portion or the second housing portion, the metal dome is configured to connect to connecting point(s) on the printed circuit board, and an electrical signal is generated to indicate whether the capacitor housing portion and the printed circuit board are correctly installed.

2. The solid-state drive with detachable capacitor housing according to claim 1, wherein the capacitor housing portion has a snap structure, the first housing portion and the second housing portion are provided with a snap fitting structure, and the capacitor housing portion is configured to be snapping fit with the first housing portion and the second housing portion.

3. The solid-state drive with detachable capacitor housing according to claim 2, wherein the snap structure includes a protruding portion, the snap fitting structure includes a recessed portion, and the protruding portion is configured to be snapping fit with the recessed portion.

4. The solid-state drive with detachable capacitor housing according to claim 1, wherein the capacitor housing portion is inserted into and connected to the first housing portion or the second housing portion.

5. The solid-state drive with detachable capacitor housing according to claim 1, wherein the capacitor housing portion is connected to at least one of the first housing or the second housing through screws.

6. The solid-state drive with detachable capacitor housing according to claim 1, wherein the capacitor housing portion includes a surface provided with a fin structure.

7. The solid-state drive with detachable capacitor housing according to claim 1, wherein the capacitor housing portion is made of plastic or carbon fiber.

8. The solid-state drive with detachable capacitor housing according to claim 1, wherein the solid-state drive also includes an electrolytic capacitor that is exposed when the capacitor housing is removed.

9. The solid-state drive with detachable capacitor housing according to claim 1, wherein the capacitor housing portion is connected to both the first housing portion and the second housing portion and the capacitor housing portion has a U-shaped section.

10. The solid-state drive with detachable capacitor housing according to claim 1, wherein the metal dome has a U-shaped cross section and the metal dome is configured to clamp the printed circuit board so that the metal dome contacts the connecting point(s) on the printed circuit board and the electrical signal is configured to serve as an indicator by converting into data display, optical signal or acoustic signal.
